(19) United States
(12) Patent Application Publication
(10) Pub. No.: US 2006/0154227 A1
(43) Pub. Date: Jul. 13, 2006

(54) Electronic classroom

(76) Inventors: Deborah W. Rossi, Lenoir City, TN (US); Davin K. Tanabe, Red Bank, NJ (US)

Correspondence Address: TAFT, STETTINIUS & HOLLISTER LLP, SUITE 1800, 425 WALNUT STREET, CINCINNATI, OH, 45202-3957, US

(21) Appl. No.: 11/328,424

(22) Filed: Jan. 9, 2006

Related U.S. Application Data
(60) Provisional application No. 60/642,195, filed on Jan. 7, 2005.

(51) Int. Cl. G09B 3/00

(52) U.S. Cl. 434/350

(57) ABSTRACT

An electronic classroom includes a teacher computer linked electronically to one or more student computers. The teacher can use the teacher computer to create or edit lessons and present lessons to the students on the student computers. The lesson includes one or more pages containing visual markings, such as text and graphics, and various input regions where students can make inputs and answer questions presented in the lesson. Student inputs can be made by a stylus, mouse, keyboard, or other input device. Using the teacher computer, the teacher can view the progress of each student through the lesson and interact with the students. A student computer can be located remotely from the classroom, such as at a student's home.

### CROSS-REFERENCE TO RELATED APPLICATION

This application claims the benefit of U.S. Provisional Patent Application Serial No. 60/642,195, filed Jan. 7, 2005, the disclosure of which is incorporated herein by reference.

### BACKGROUND OF THE INVENTION

The present invention relates to an electronic classroom that facilitates information sharing between a teacher and students for interactive learning.

### SUMMARY

The present invention provides an electronic classroom that allows a teacher, using a teacher's computer, to guide a plurality of students along a series of lessons (and other classroom activities) in which the students will access and follow the lessons using their own computers, which are electronically linked to the teacher's computer.

Accordingly, it is a first aspect of the present invention to provide an electronic classroom including: a teacher computer adapted for use by a teacher, the teacher computer having a display device and an input device; at least one student computer adapted for use by a student and connected to the teacher computer via a data link, the student computer having a display device and an input device; where the student computer includes software that provides a graphical user interface that displays an interactive lesson; and where the teacher computer includes software that provides a graphical user interface that allows a teacher to manipulate the output of the student computer's interactive lesson by making control inputs with the teacher computer's input device; and where the teacher computer graphical user interface allows the teacher to configure the teacher computer's display device, by making control inputs with the teacher computer's input device, to display inputs made by the student in the interactive lesson; whereby the teacher can guide students through the interactive lesson and monitor the student's progress. Inputs can be made using a mouse, keyboard, voice recognition device, trackball, motion sensor device, scanner device, touch-sensitive screen, stylus, electronic whiteboard, and similar input devices.

In a detailed embodiment, the teacher can select a lesson from a list of available lessons and select a page of the lesson to be displayed on the student computers. A student can select a lesson from a list of available lessons and select a page of the lesson to be displayed on his or her student computer, if so permitted by the teacher. The lesson can include one or more input regions prompting the student to make inputs, which can be answers to questions, commands to display a new page of the lesson, or commands to terminate the student's work on the lesson. The teacher computer can include a follow-me function that forces the students to follow the teacher's progression through the lesson. In an alternate detailed embodiment, the teacher computer can include a grading function that analyzes the students' responses and generates a report card summarizing each student's performance. In an alternate detailed embodiment, a read-to-me function plays a sound recording associated with text or graphics being displayed. The teacher computer and student computers can be adapted to provide support for multiple languages. In an embodiment, the language support includes the ability to present a lesson to the teacher in a language associated with the teacher, and to present the lesson to a student in a language associated with the student.

The above-described embodiments can also be practiced with a plurality of student computers connected to the teacher computer via a data link. The teacher can define subgroups of students that can share work in peer groups by allowing each student in such a subgroup to view inputs made by other students in the subgroup. Using the teacher computer, the teacher can view the display of any student's computer, or of all the students' computers simultaneously, thereby allowing the teacher to follow the students' progress through the lesson. In a detailed embodiment, support can also be provided for a remote computer to communicate with the teacher computer or with one of the student computers via a data link, which can be an Internet link, thus allowing a remotely-located user to monitor the teacher's or a student's work or participate in the lesson.

It is a second aspect of the present invention to provide a method of classroom instruction, including the steps of: (a) providing a teacher computer and a plurality of student computers operatively coupled by a data link, each of the student computers including software for providing a graphical user interface, which provides a lesson to the student, and the teacher computer including software for providing a graphical user interface for monitoring and controlling the lessons on the student computers; (b) selecting a lesson on the teacher computer graphical user interface by a teacher; (c) selecting a plurality of students on the teacher computer graphical user interface by the teacher; (d) presenting the selected lesson to the selected plurality of students on the plurality of student computer graphical user interfaces; (e) receiving inputs by the teacher computer software from each of the selected plurality of students using the student computer graphical user interfaces; and (f) presenting a response generated by the teacher using the teacher computer input device to at least one of the selected plurality of students on the student computer graphical user interface. The steps of this method can be performed substantially in real time or can be performed in a time-separated mode. In detailed embodiment, the teacher can choose a lesson from a list of available lessons, or compose a new lesson. The teacher can present individual portions or pages of a lesson to students by making control inputs to the teacher computer.

These and other aspects and embodiments will be apparent from the following description, the accompanying drawings, and the appended claims.

### BRIEF DESCRIPTION OF THE DRAWINGS

FIG. 1 shows a schematic diagram of the electronic classroom, according to an exemplary embodiment of the present invention.

FIG. 2 is a screen view showing the icon on the Windows® desktop to launch the electronic classroom application, according to an exemplary embodiment of the present invention.

FIG. 3 is a screen view showing the list of names or identification labels for users of the electronic classroom, according to an exemplary embodiment of the present invention.

FIG. 4 is a screen view showing the icons for the basic tools for the electronic classroom, according to an exemplary embodiment of the present invention.

FIG. 5 is a screen view showing the icons for the basic teacher functions for the electronic classroom, according to an exemplary embodiment of the present invention.

FIG. 6 is a screen view showing a list of the available classrooms/periods for the teacher to select from, according to an exemplary embodiment of the present invention.

FIG. 7 is a screen view showing a classroom setup screen that allows the teacher to move students in and out of a selected classroom, according to an exemplary embodiment of the present invention.

FIGS. 8 through 10 are screen views showing an electronic classroom work page for the teacher, according to an exemplary embodiment of the present invention.

FIG. 11 is a screen view showing a list of lessons available for the teacher to load, according to an exemplary embodiment of the present invention.

FIG. 12 is a screen view showing a screen that prompts the teacher to enter a name and number of pages for a new lesson, according to an exemplary embodiment of the present invention.

FIG. 13 is a screen view showing a blank work page for a new lesson, according to an exemplary embodiment of the present invention.

FIG. 14 is a screen view showing a splitscreen function that allows the teacher to control functions relating to the student computers, according to an exemplary embodiment of the present invention.

FIG. 15 is a screen view showing various aspects of the operation of the student computers, according to an exemplary embodiment of the present invention.

FIGS. 16(a) and 16(b) illustrate the ability to present a lesson in a student's native language that is different from the teacher's native language, according to an exemplary embodiment of the present invention.

FIGS. 17 and 18 are screen views showing various aspects of the operation of the student computers, according to an exemplary embodiment of the present invention.

### DETAILED DESCRIPTION

The present invention provides an electronic classroom that allows a teacher, using a teacher's computer, to guide a plurality of students along a series of lessons (and other classroom activities) in which the students will access and follow the lessons using their own computers, which are electronically linked to the teacher's computer. The invention allows the teacher to obtain immediate feedback and monitoring of the students' progress through the various lessons and activities, allows the teacher to provide individualized instructions to the students, and also allows the teacher to correspond with and guide students in remote locations such as between the teacher and the student's home. Communication between the teacher and students can occur in real-time or in a time-separated mode, which can be useful for distance learning where participants may be separated across time zones or otherwise not available for simultaneous interaction.

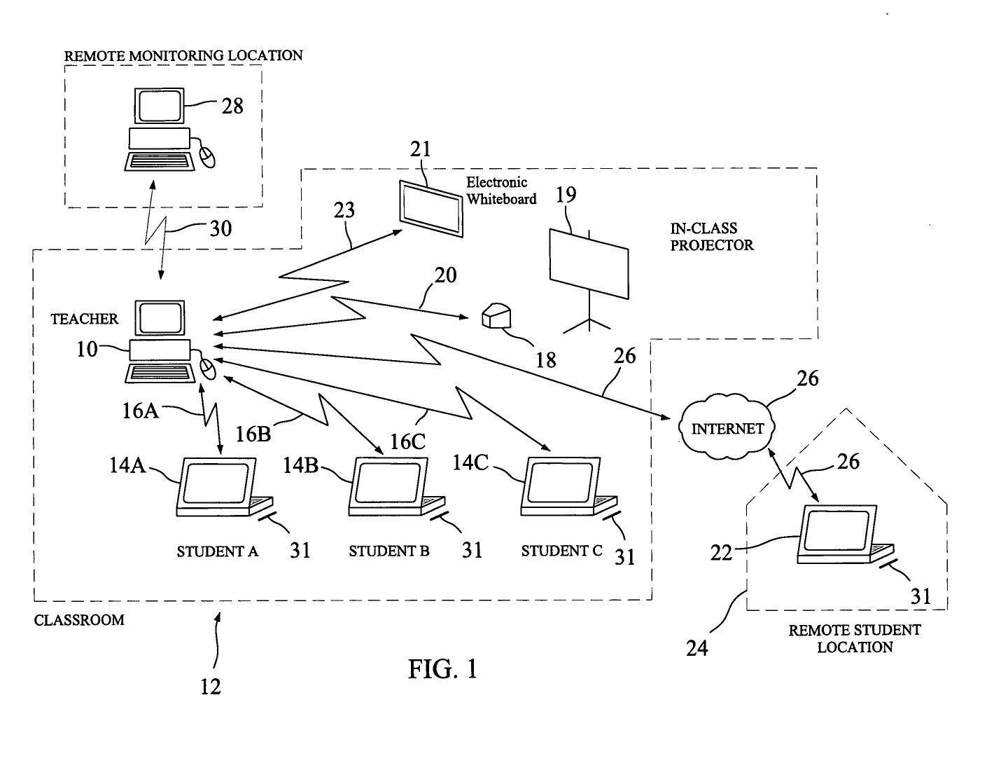

As shown in FIG. 1, in an exemplary embodiment, a teacher's computer 10 located in classroom 12 is electronically coupled to a plurality of student computers 14a-14c over data connections 16a-16c, where the student computers are also located within the classroom 12. The teacher computer can also be operatively coupled to a projector 18 over a data link 20 where the projector projects a display (such as the same display on the teacher's computer or another display directed by the teacher's computer) on screen 19, which is viewable by the students operating student computers 14a-14c. Additionally, the teacher computer can be operatively coupled to an electronic whiteboard 21 over a data link 23 where the whiteboard captures images drawn or traced thereon (with a stylus or marker, for example) and provides such images as inputs to the teacher computer. Optionally, the electronic whiteboard 21 can also be used as a screen onto which the image from projector 18 can be projected. In an exemplary embodiment, the teacher computer 10 may also be operatively coupled to a remote student computer 22 at a remote student location 24 over an appropriate data link, such as an internet link 26. Additionally, a remote monitoring computer 28 (operated by a school principal or a parent, for example) may also be operatively coupled to the teacher computer 10 over an appropriate data link 30.

In the exemplary embodiment, the student computers 14a-14c and 22 and the teacher computer 10 are tablet PCs operating an appropriate version of Windows® XP Tablet PC Operating System software onto which application code for performing the application functions set forth herein operate. Alternatively, one or more of the student computers 14a-14c and 22 and the teacher computer 10 can be other types of computers, such as desktop PCs or laptop PCs. It will be apparent to one of ordinary skill in the art how to program the applications described herein using the various tools and resources provided by the Windows® XP Tablet PC Operating System or any other suitable substitute. It is also within the scope of the invention that one of ordinary skill in the art could program the applications and functions described herein from scratch. As known by those of ordinary skill, in the exemplary embodiment, the tablet PCs each have a stylus 31 for use by the students to input data by touching the screen of the tablet PC and moving the stylus thereabout (such as writing or drawing on the screen). Those of ordinary skill in the art will appreciate that any alternate form of computer input device may also be used with or in place of the stylus; such alternate computer input devices include, without limitation: mouse devices, keyboard devices, voice recognition devices, trackball devices, motion sensor devices, scanner devices, touch-sensitive screens, and the like.

The data links (16a-16c, 20, 23, 26, and 30) described herein can be any wired or wireless data connection available to one of ordinary skill in the art. In exemplary embodiments, the teacher computer 10 and the student computers 14a-14c communicate wirelessly over wireless data links 16a-16c using TCP or UDP protocols. Using these data links, any combination of the teacher computer 10, student computers 14a-14c, remote student computer 22, and remote monitoring computer 28 can communicate. For example, all of these computers can be connected to share data, or the teacher computer can share data with a subset of the student computers, or the teacher computer can be isolated from the other computers. A “follow me” feature can be provided that allows the teacher to network all the other computers with the teacher, thus allowing the teacher computer to send outputs to, and receive inputs from, each of the other computers. This mode of operation can be configured so that the students can view inputs made by the teacher. Inputs made by the teacher using the pen tool or other graphic tools (as described below) on the teacher computer 10 can be viewed by the students on their student computers 14a-14c, and inputs made by the students using the pen tool or other graphic tools on their student computers 14a-14c can be viewed by the teacher on the teacher computers 10. Similarly, students can be linked in small groups that allow students to view the work of other students in the group, such as messages written by other students.

As one of ordinary skill in the art will understand, the Windows® XP Tablet PC Operating System software and appropriate PC hardware and peripherals provide such wireless and/or wired networking support. Furthermore, while the teacher computer 10 and the remote student computer 22 are shown in the exemplary embodiment as connected to one another over an internet data link 26, it will be appreciated by those of ordinary skill in the art that other data links for remote communication between the remote student computer 22 and the teacher computer 10 are available. Similar data links may also be suitable for the data link 30 provided between the remote monitoring computer and the teacher computer 10.

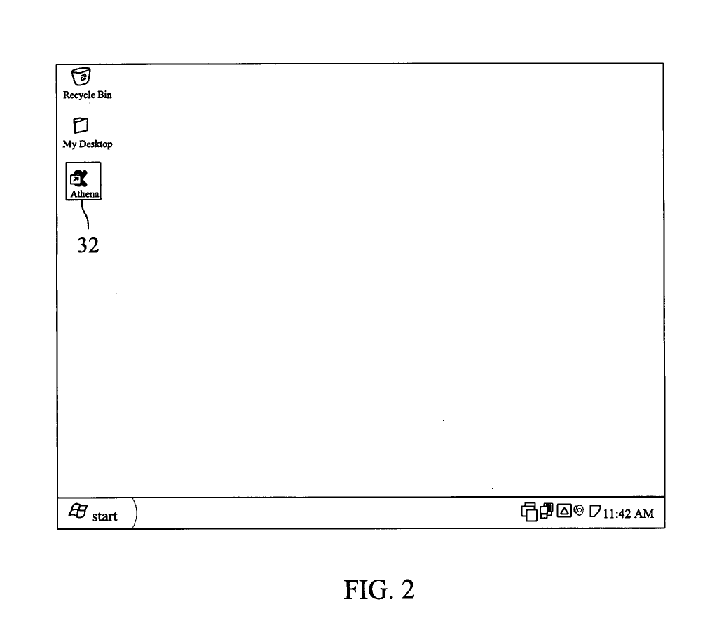

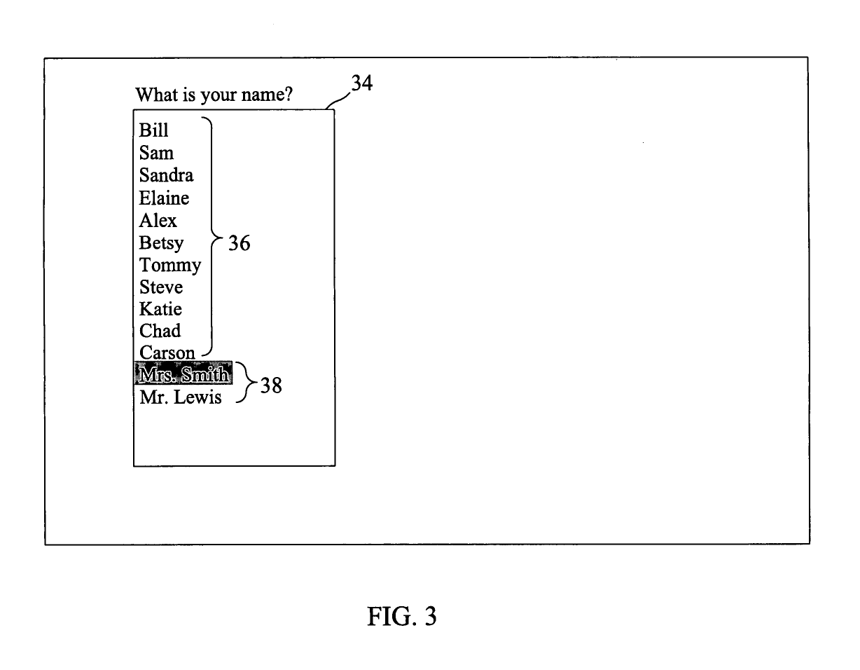

The remainder of this application will describe the various functionality programmed into the electronic classroom software operating on each of the teacher computer 10, student computers 14a-14c, remote student computer 22, and remote monitoring computer 28. As shown in FIG. 2, the start of the process for each user is to double click on the application program icon 32 on the user's Windows® desktop. The next screen, as shown FIG. 3, will be the log-in screen in which a list of names will be provided in a field 34 from which a student can select his or her student name from a list of student names or numbers 36 or the teacher can select a teacher identification 38 from the list. Once a name or identification is selected, appropriate log in (ID and password) steps will then be utilized to verify that the student and/or teacher has the appropriate access rights.

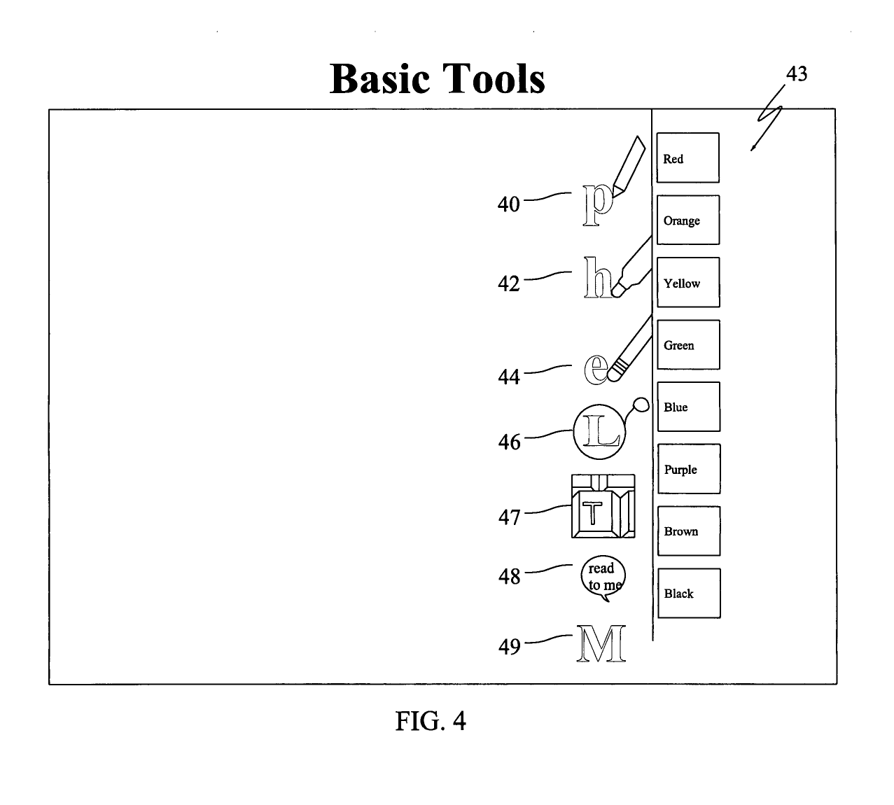

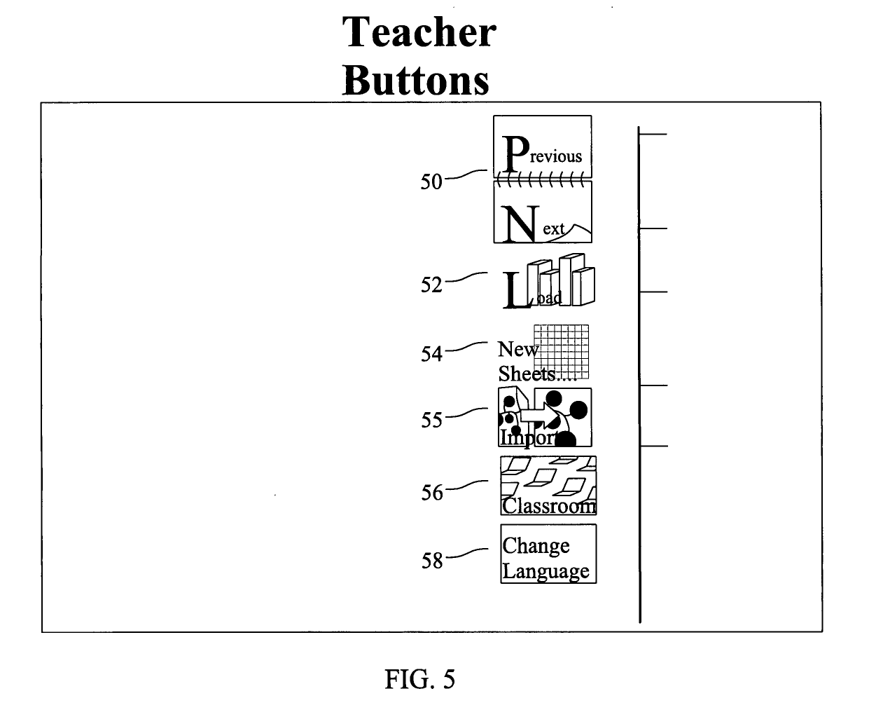

The teacher desktop screen will have basic tools as shown in FIG. 4 and basic teacher buttons as shown in FIG. 5. Referring to FIG. 4, the basic tools include a draw or pen tool activated by a draw/pen tool icon 40, a highlight tool activated by a highlight tool icon 42, an eraser tool activated by an eraser tool icon 44, a lasso tool activated by a lasso icon 46, a typing tool activated by a typing tool icon 47, a “read to me” tool activated by a “read-to-me” icon 48, and an electronic manipulative tool (or “M tool”) activated by an associated icon 49. This M tool can be used to access functions that perform arithmetic functions (such as add, subtract, multiply or divide numbers) or manipulate sets of tessilations, letters, geometric shapes, or other objects. For example, the M tool can be used to perform manipulations relating to properties of U.S. coins, atomic and molecular representations, rulers and other real-world measuring devices, and other objects familiar to elementary school-aged children, such as apples and oranges. Each of the manipulatives provided by the M tool can be accessed by an icon, and previously-used icons can be held in a “trashcan” storage memory for reuse. A color palette 43 allows the user to select the color to be used by the currently selected tool. As shown in FIG. 5, the basic teacher buttons include a “page-turn” tool activated by an associated icon 50, a load lesson tool activated by an associated icon 52, a new sheets tool activated by an associated icon 54, an import tool activated by an associated icon 55, classroom tool activated by an associated icon 56, and a change language tool activated by an associated icon 58. The change language tool allows the user to select a language from a list of available languages to be used for displayed text and text inputs.

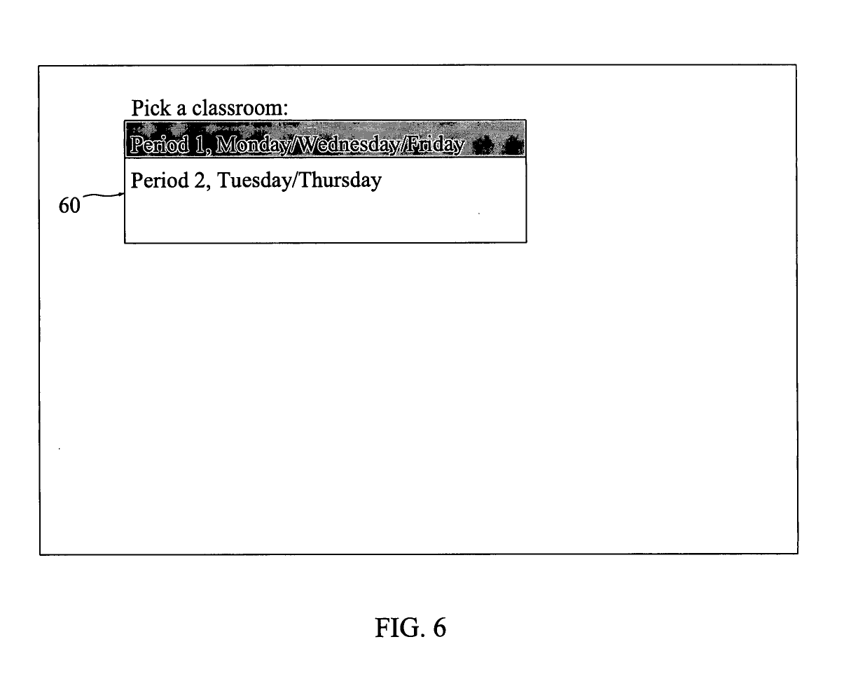

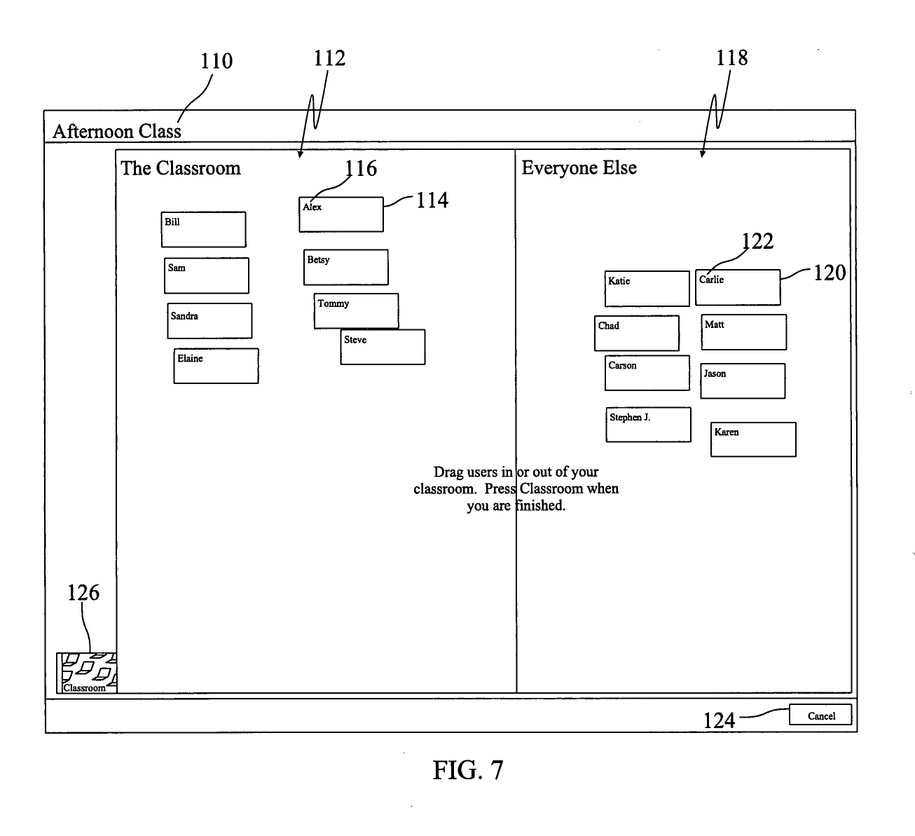

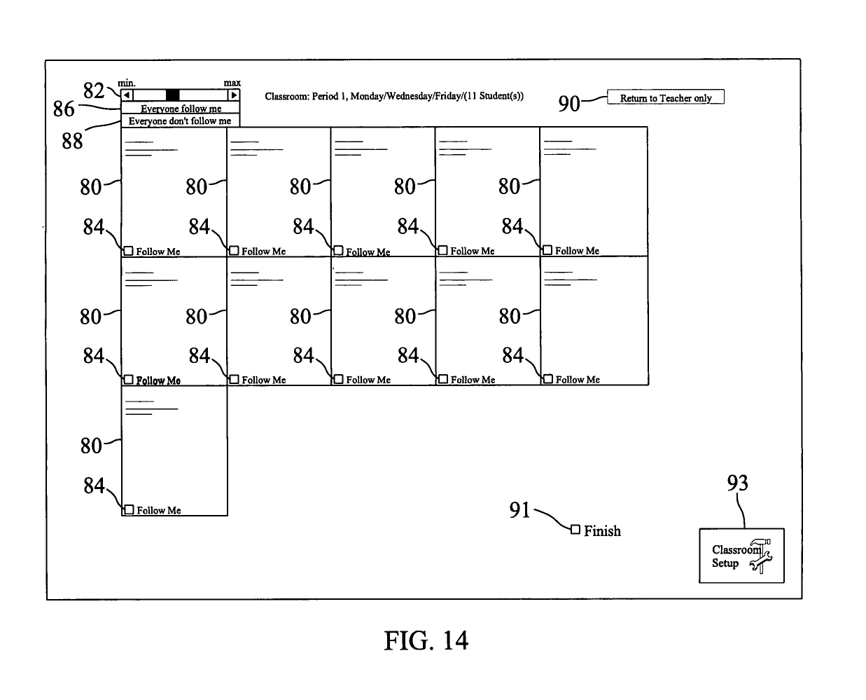

As shown in FIG. 6, upon a teacher logging into the system, a teacher will first be provided with a selection menu 60 requesting the teacher to pick a classroom/period from the list of available classroom/periods. Depending upon the selection, the system can obtain the profiles of the students associated with that selected classroom and can also be linked to the associated lesson results and other associated data for performing the methods described herein. After selecting a classroom, or at any time upon selecting the classroom setup tool 93 (discussed below with reference to FIG. 14), the teacher can revise the roster of students in that classroom, as shown in FIG. 7. In this classroom setup screen, the name of the classroom is shown in the area 110 at the top. The left window 112 shows the students currently assigned to that classroom, each student being represented by an icon 114 containing the student's name or identifier 116. The right window 118 shows the remaining students who have not been assigned to this particular classroom, each such student being represented by an icon 120 containing the student's name or identifier 122. The teacher can use his or her computer's mouse or other input device to click and drag individual student icons to move students in or out of the selected classroom. Using this procedure, the teacher can add students to the classroom by moving them from the right window 118 to the left window 112, and the teacher can remove students from the classroom by moving them from the left window 112 to the right window 118. At any time during the classroom setup process, the teacher can restore the classroom to its previous composition by clicking on the “Cancel” button 124. When finished making any changes to the classroom roster, the teacher can click on the “Classroom” button 126 to exit this classroom setup feature.

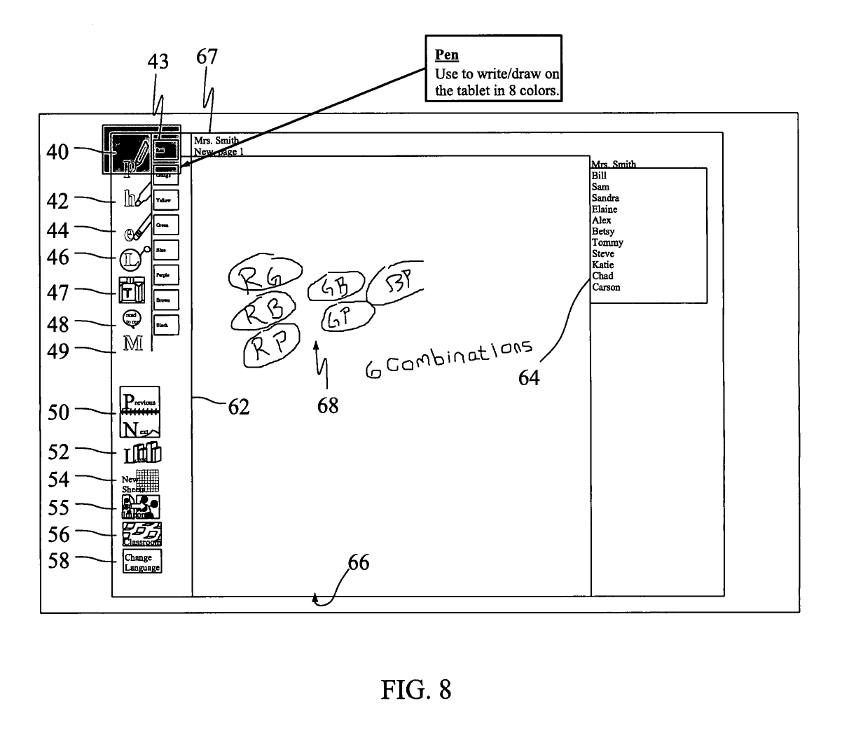

As shown in FIG. 8, an exemplary work page for the teacher will have the teacher buttons 50-59 and basic tools 40-48 positioned in a left column segment 62 of the page. The right column segment of the page will include one or more lists 64 in which the teacher can select one of several listed students. Each list controls the display of an attached monitor or computer. In the case of a standalone computer, there is one list to control the computer's internal display, plus a second list to control a projector or external monitor (if any is attached), thus allowing the user to independently select either display. The middle of the work page is a large work area 66 for displaying the lesson plans, electronic white board, and the like. Above the work area 66, the user's identification (“Teacher” in the example of FIG. 8) and the lesson name (“New” in the example of FIG. 8) are displayed in a title bar 67.

The embodiment shown in FIG. 8 depicts the electronic white board application running in the work area 66. It also displays the operation of the pen tool 40, which allows the teacher to use his or her stylus 31 for sketching/printing indicia 68 on the white board which is automatically displayed on the white board areas of the students' computers (as described below) who are following the teacher's lesson. When the stylus is used to make inputs, a text recognition feature can convert a handwritten text input into alphanumeric characters to be displayed. Similar to the pen tool 40, the highlight tool 42 will allow the user to highlight indicia work area 66, the erase tool 44 will allow the user to remove indicia from the work area 66, and the lasso tool 46 will allow the user to draw a “lasso” around particular indicia in the work area 66, which then may be moved, deleted, copied, etc. using appropriate utilities as known to those of ordinary skill.

A “see teacher” feature can be provided on the students' computers that allows the student to view written inputs made by the teacher on the teacher computer. Similarly, a “see student” feature can be provided on the students' computers that allows each student to view his or her own written inputs made on the student computer.

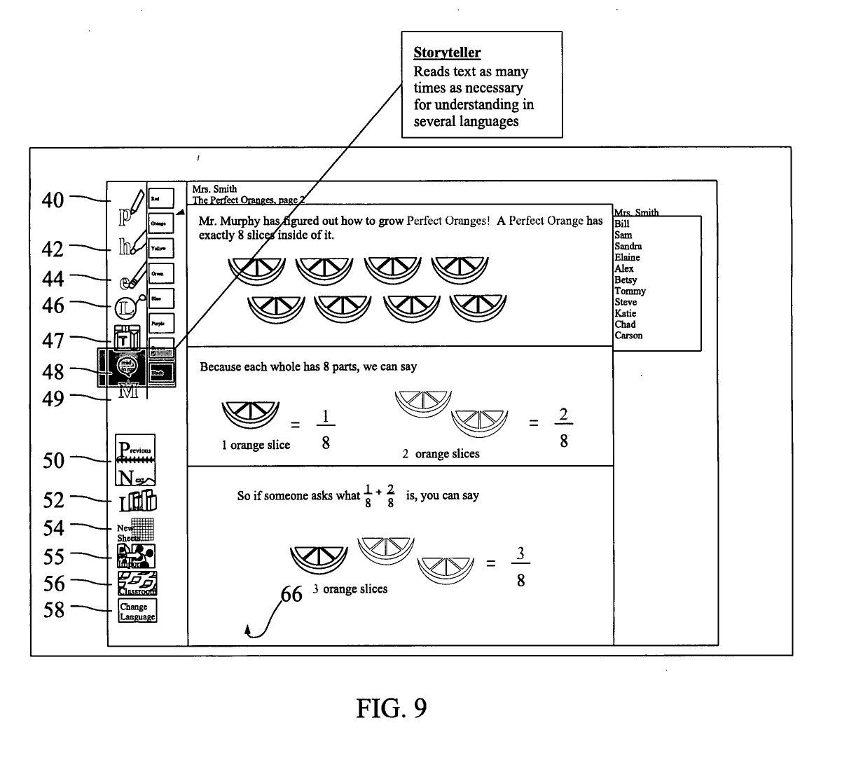

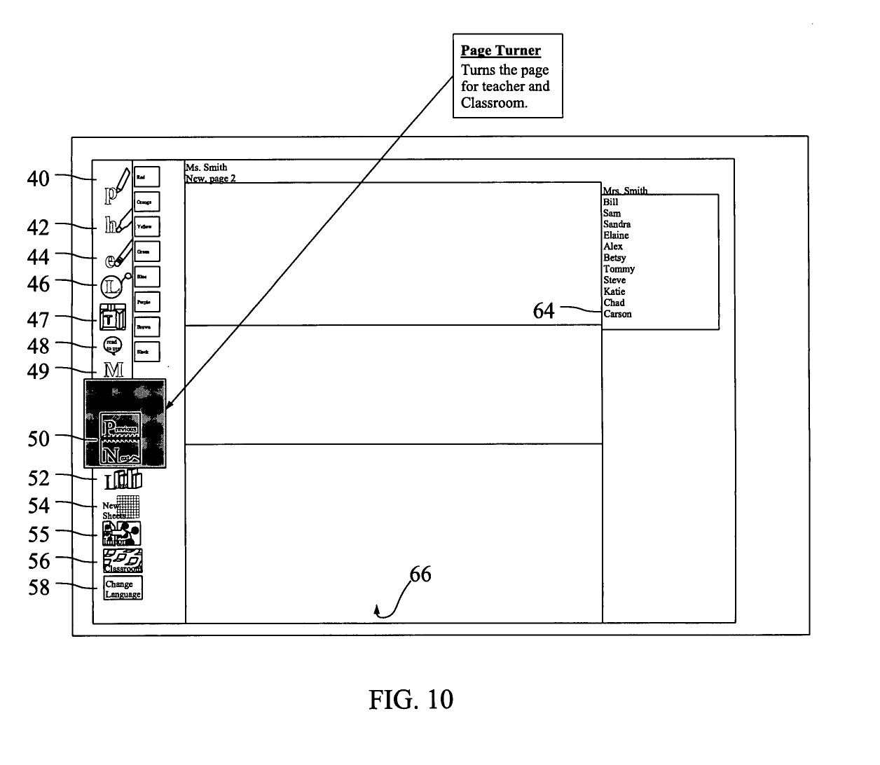

The work area 66 of FIG. 9 also shows a page of a lesson displayed therein, where the lesson page will be also shown in the corresponding work areas of the students that are following the teacher. As shown in FIG. 10, the page turner icon 50 is separable into “previous” and “next” icons, which, when activated, will take the teacher and the following students to respective previous and next pages of an associated lesson or white board.

Also shown in FIG. 9 is the “read to me” tool 48 which, when selected, causes the system to play to the user an audio reading of the text and numbers depicted on the display page of a particular lesson. The system can be adapted to allow the page to be read in any of several selected languages. The “read to me” tool can also establish a relationship between graphics and spoken text, for example, by allowing a picture of an orange to cause the word orange to be spoken when the picture is “read” using the “read to me” function.

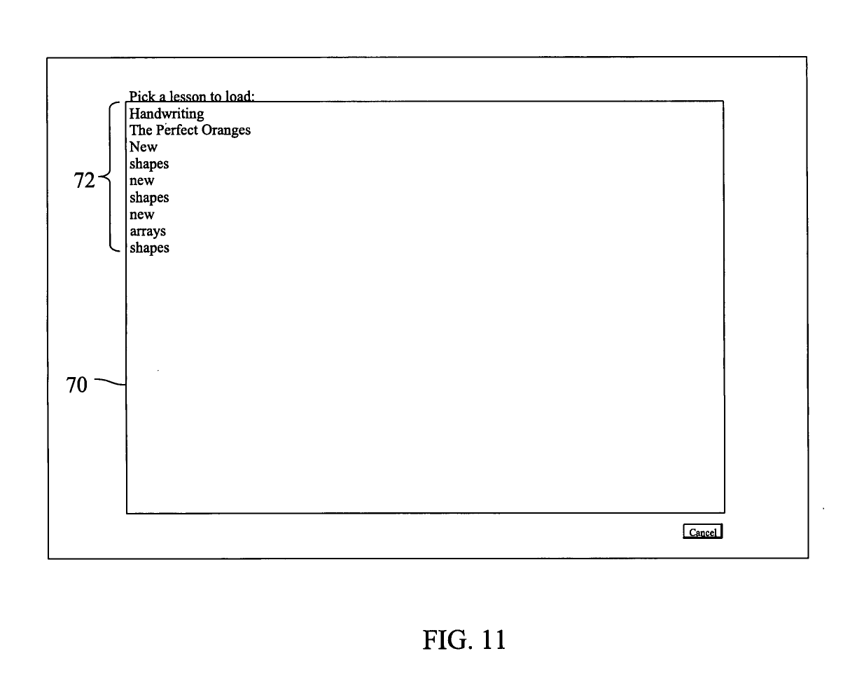

As shown in FIG. 11, when the load tool 52 (discussed above with reference to FIG. 5) is activated, the teacher will be provided with a field 70 requesting the teacher to pick a lesson from a group of lessons 72. Once selected, the lesson will be brought up on the teacher's work area 66 and also on the associated work areas of the students following the teacher at the particular time.

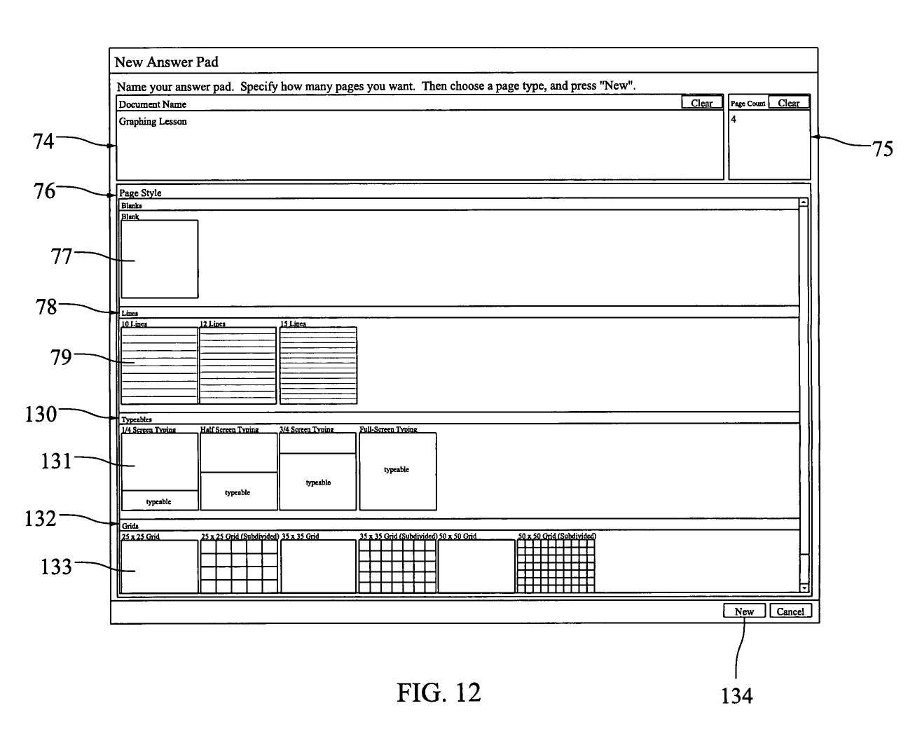

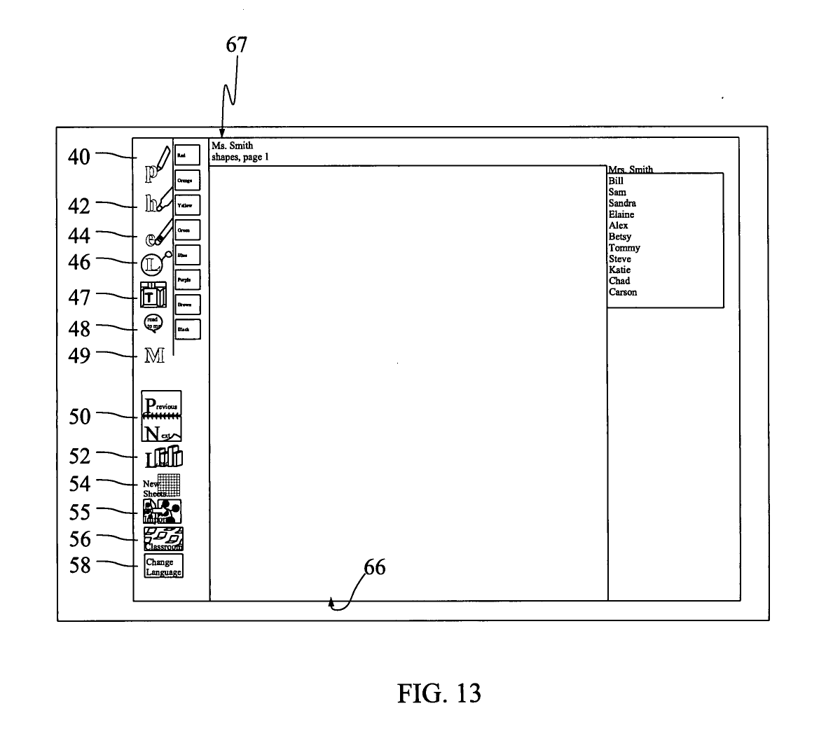

As shown in FIGS. 12 and 13, when the new sheets icon 54 (discussed above with reference to FIG. 5) is selected, a utility will be activated that allows the teacher to create a new lesson or set of sheets before or during class. The new sheets tool displays a screen shown in FIG. 12 that first prompts the teacher to enter a name for the new lesson in box 74 and the number of pages for the new lesson in box 75. The teacher is then presented with several options for the page style of the new sheets. The teacher can choose a background format for the pages in box 76 containing one or more background selections 77. The teacher can choose a format for lines on the page in box 78 presenting one or more choices 79, a format for typeable area on the page in box 130 presenting one or more choices 131, and a format for grid lines on the page in box 132 presenting one or more choices 133.

Once the page style selections have been made, the teacher can click on the New button 134, and the application will lead to a blank new lesson work area 66 into which the teacher can begin creating the new lesson, as discussed above. This new lesson work area is shown in FIG. 13. In addition, the new lesson can be a blank screen, grid paper, lined paper, columnar, tabular, or user-defined by loading external documents to use as the background image. Alternatively, the teacher can create a new lesson using text, graphics, and other content contained in an external document by importing that document using the import tool 55. After the external document is imported, the teacher can use the tools described above to edit the lesson.

As shown in FIG. 14, when the classroom icon 56 (discussed above with reference to FIG. 5) is selected, representations 80 for each student in the class are provided on the teacher's work screen. Each representation 80 is a box that will have the name or other indication of the student, the lesson that the student is presently attending to, and a miniaturized depiction of what is displayed on the student's work area at the present time. The classroom screen provides a slide control 82 in which the teacher can reduce or enlarge the size of the boxes 80. Each box also includes a field 84 activatable by the teacher to force one or more of the students to “follow” the teacher's work area. This allows the teacher to control the page turns of the users and interact with the users who are connected. The screen also includes a button 86 to require all the students to follow (checking all boxes 84); and an opposite button 88 releasing all students from following (unchecking all the boxes 84). From this classroom screen, the teacher can access the classroom setup screen (discussed above and shown in FIG. 7) by clicking on the classroom setup icon 93, thereby allowing the teacher to modify the roster of students in the classroom. A button 90 will take the teacher back to his/her work area screen. Finally, a finish button 91 allows the teacher to halt any further inputs by students, thus ending students' ability to change their work. The teacher can uncheck the finish button if necessary to enable students to continue working.

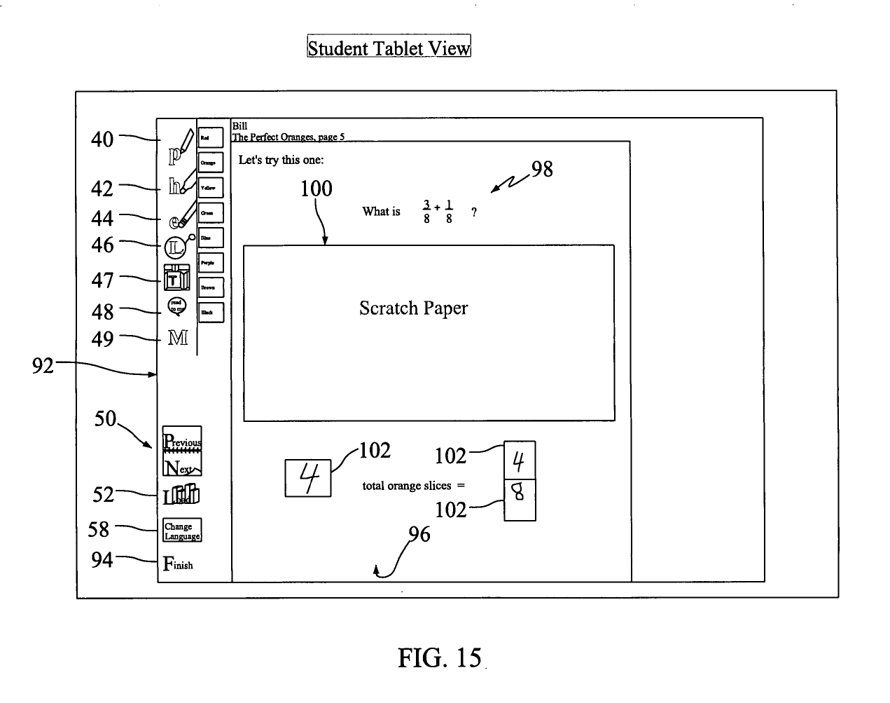

As shown in FIG. 15, a student work page can include a left column block 92 having tools 40-48 and several student buttons such as the previous/next buttons 50, the load lesson button 52 (allowing the students to select their own lessons when so permitted by the teacher), and the change language button 58. The students' buttons also include a finish button 94. The work area 96 of the students' work page includes the various lessons worked on by the student or other applications such as notebook or white board areas in which the students can take notes, etc. In the example lesson plan shown in FIG. 15, a math equation 98 is given at the top of the work area 96, a scratch paper area 100 is given in which the student can use his/her stylus 31 to work out the problem, and then answer areas 102 in which the student can type or write in the answers to the math equation 98. The student can enter text with the stylus, and a text recognition feature can convert the handwritten input to alphanumeric characters, as described above with respect to the teacher computer's operation.

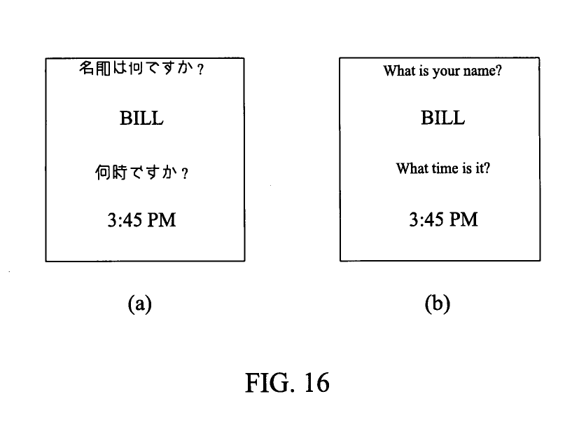

FIGS. 16(a) and 16(b) illustrate the ability to present a lesson in a student's native language that is different from the teacher's native language, according to an exemplary embodiment of the present invention. In the example shown, a Japanese-speaking teacher could view the work of an English-speaking student, showing the Japanese background of the lesson on the teacher computer (as depicted in FIG. 16(a)), while the student would see the English version of the lesson on the student computer (as depicted in FIG. 16(b)).

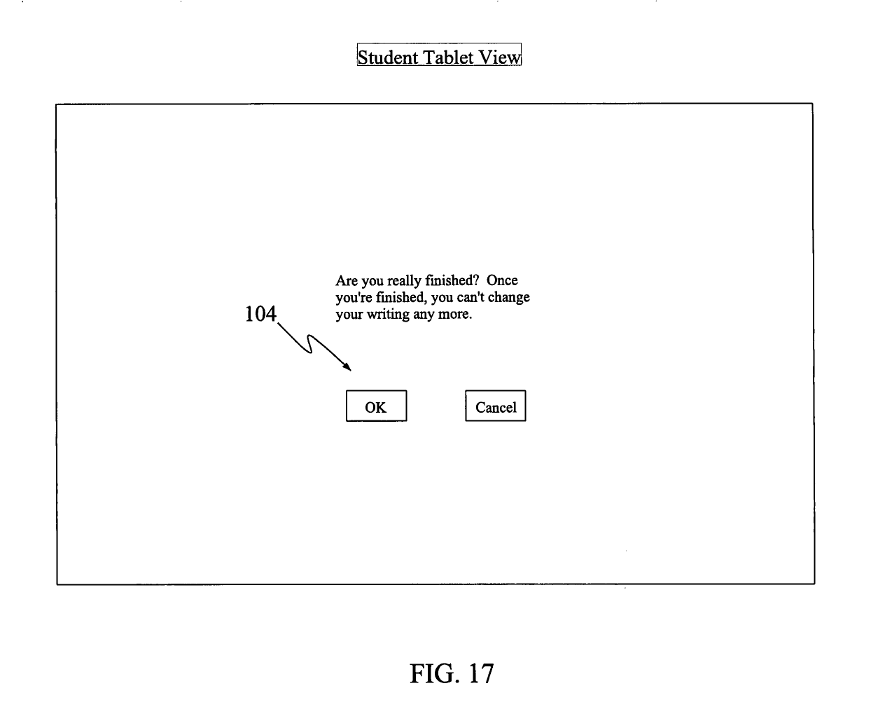

Once the student is satisfied that he or she has entered the correct answer, the student will then activate the finish button 94. As shown in FIG. 17, when the finish button is activated, the student's work screen will provide a query 104 requesting the student to confirm that he or she wishes to finish the particular lesson page and move on to the next page. It is noted that in this lesson plan the student will not be able to change his or her answer once the finish button is confirmed.

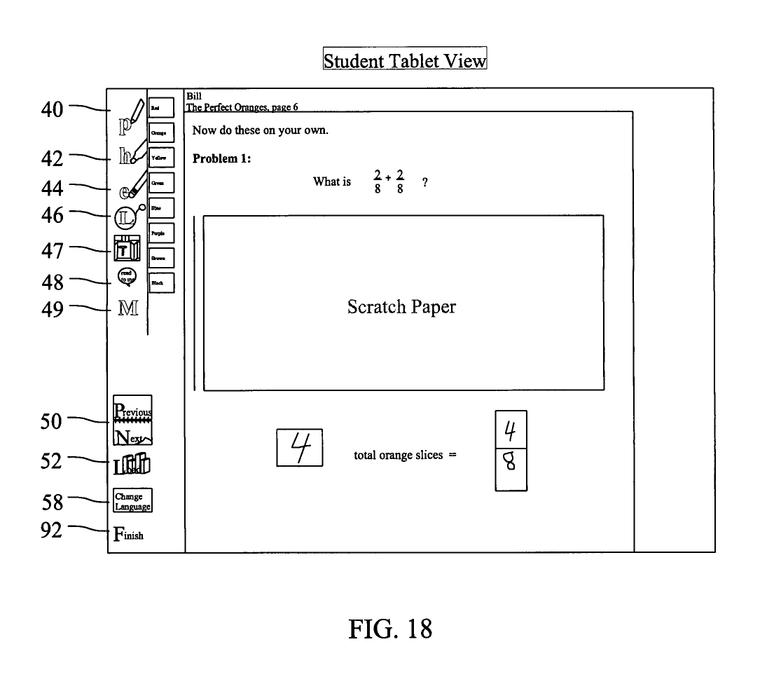

As shown in FIG. 18, once the student has completed the finish process, his or her responses are frozen on the screen. As discussed above, the teacher can review the student's work at his or her leisure at any time. Alternatively, the teacher computer software can include a grading function that compares a student's responses with a pre-determined reference, such as a set of answers for a particular lesson. This grading function can provide the teacher with the results of the student's work, such as percentage of correct answers, and can generate a report card summarizing the student's work. Optionally, the report card can include a comparison of the student's performance to the performance of other students in the class. The teacher can select a visual symbol describing the student's performance, such as a “Good Job!” stamp or a smiling-face symbol, to be included on the report card. The report card can then be made available for the student to view on the student computer.

Having described the invention with reference to exemplary embodiments, it is to be understood that the invention is defined by the claims and it is not intended that any limitations or elements describing the exemplary embodiment set forth herein are to be incorporated into the meanings of the claims unless such limitations or elements are explicitly listed in the claims. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. An electronic classroom comprising:
a teacher computer adapted for use by a teacher, the teacher computer having a display device and an input device;
at least one student computer adapted for use by a student and connected to the teacher computer via a data link, the student computer having a display device and an input device; wherein
the student computer includes software that provides a graphical user interface that displays an interactive lesson; wherein
the teacher computer includes software that provides a graphical user interface that allows a teacher to manipulate the output of the student computer's interactive lesson by making control inputs with the teacher computer's input device; and wherein
the teacher computer graphical user interface allows the teacher to configure the teacher computer's display device, by making control inputs with the teacher computer's input device, to display inputs made by the student in the interactive lesson;
whereby the teacher can guide students through the interactive lesson and monitor the student's progress.

2. The electronic classroom of claim 1, wherein
at least one of the teacher computer graphical user interface and student computer graphical user interface includes a function that enables the user to select a lesson from a list of available lessons, the lesson including at least one page that can be displayed on the student computer's graphical user interface; and wherein
at least one of the teacher computer graphical user interface and student computer graphical user interface includes a function that enables the user to select a page of the lesson to be displayed on the student computer's graphical user interface.

3. The electronic classroom of claim 2, wherein
at least one page of the lesson on the student computer's graphical user interface includes at least one display region containing visual markings and at least one input region prompting the student to make an input using the student computer's input device.

4. The electronic classroom of claim 3, wherein:
the input region prompts the student to make an input that includes an answer to a question displayed in the display region.

5. The electronic classroom of claim 3, wherein
the input region prompts the student to make an input that causes another page of the lesson to be displayed.

6. The electronic classroom of claim 3, wherein
the input region prompts the student to make an input indicating that the student has finished the lesson; and wherein
after making said input, the student will be unable to change inputs that were previously made in response to input regions.

7. The electronic classroom of claim 3, wherein
the teacher computer graphical user interface includes a finction that enables the teacher to freeze inputs previously made by the student, thereby preventing the student from changing said inputs.

8. The electronic classroom of claim 3, wherein
the teacher computer graphical user interface includes a follow-me function that, when enabled by the teacher, restricts the student's ability to make inputs into input regions.

9. The electronic classroom of claim 8, wherein
the follow-me function allows the teacher to present a single input region to the student, thereby forcing the student to follow the teacher's progression through the lesson.

10. The electronic classroom of claim 3, wherein
the teacher computer graphical user interface includes a grading function that compares the student's input made in the input region to a pre-determined reference, thereby enabling the teacher to grade the student's responses.

11. The electronic classroom of claim 10, wherein
the grading function generates a report card summarizing the student's performance, as determined from the student's inputs made in the input regions of the lesson.

12. The electronic classroom of claim 11, wherein
the grading function enables the teacher to insert a visual symbol describing the student's performance into the report card.

13. The electronic classroom of claim 12, wherein
the report card and visual symbol can be viewed by the student on the student computer graphical user interface.

14. The electronic classroom of claim 11, wherein
the report card includes a comparison of the student's performance to the performance of other students.

15. The electronic classroom of claim 11, wherein
the grading function retrieves at least one page of the lesson from which the report card is generated, the page including an input made in an input region by the student, and associates the page with the report card;
whereby the page from the lesson is available for presentation along with the report card.

16. The electronic classroom of claim 3, wherein
text is displayed on the teacher computer graphical user interface and the student computer graphical user interface in a language selected from a plurality of available languages.

17. The electronic classroom of claim 16, wherein
at least one of the teacher computer software and the student computer software includes a function that translates text from a first language to a second language.

18. The electronic classroom of claim 17, wherein
a language is associated with a user.

19. The electronic classroom of claim 18, wherein
the teacher associates a language with the student.

20. The electronic classroom of claim 19, wherein
the lesson is presented in the language associated with the student.

21. The electronic classroom of claim 17, wherein
the teacher computer graphical user interface displays the lesson in a language associated with the teacher, and wherein
the student computer graphical user interface displays the lesson on a language associated with the student.

22. The electronic classroom of claim 3, wherein
the student computer software includes a function that plays a sound recording associated with a display region.

23. The electronic classroom of claim 22, wherein
the sound recording is a spoken language verbalization of text contained in the display region.

24. The electronic classroom of claim 23, wherein
the spoken language used in the sound recording is selected from a plurality of available languages.

25. The electronic classroom of claim 3, further comprising:
a stylus adapted for making inputs to at least one of the teacher computer and the student computer; wherein
a user can enter visual markings into an input region by moving the stylus across a substrate.

26. The electronic classroom of claim 25, wherein
at least one of the teacher computer software and the student computer software includes a text recognition function that discerns alphanumeric characters in the visual markings entered into an input region by moving the stylus across a substrate.

27. The electronic classroom of claim 3, wherein
the teacher computer graphical user interface includes a new sheets function that enables the teacher to compose a lesson; wherein
the teacher composes the lesson by performing the steps of:
(a) defining one or more display regions on the page;
(b) entering visual markings to be displayed in the display areas;
(c) defining one or more input regions on the page;
(d) specifying a reference to be associated with the input region, defining a correct response; and
(e) repeating steps (a) through (d) for each page of the lesson.

28. The electronic classroom of claim 27, wherein
the defining step (c) and specifying step (d) are performed by using an answer template that defines one or more input regions and specifies a reference to be associated with the input region.

29. The electronic classroom of claim 1, further comprising:
a screen; and
a projector connected to the teacher computer via a data link and adapted to reflect a visual image rendered by the projector; wherein
the teacher can manipulate the output of the projector by making control inputs with the teacher computer's input device.

30. The electronic classroom of claim 1, further comprising:
an electronic whiteboard connected to the teacher computer via a data link and adapted to provide inputs to the teacher computer via said data link; wherein
the electronic whiteboard captures images drawn or traced thereon and provides said images as inputs to the teacher computer.

31. The electronic classroom of claim 1, further comprising:
a plurality of student computers connected to the teacher computer via a data link.

32. The electronic classroom of claim 31, wherein
the teacher computer graphical user interface is configured to selectively display the images that are being displayed on the graphical user interfaces of any subgroup of the plurality of student computers.

33. The electronic classroom of claim 31, wherein
the teacher computer software is configured to allow the teacher to manipulate the output of any one of the plurality of student computer graphical user interfaces by making control inputs with the teacher computer's input device.

34. The electronic classroom of claim 31, wherein
the teacher computer software is configured to allow the teacher to manipulate the output of any subgroup of the plurality of student computer graphical user interfaces by making control inputs with the teacher computer's input device.

35. The electronic classroom of claim 31, wherein
the teacher computer software is configured to allow the teacher to configure the student computers, by making control inputs with the teacher computer's input device, such that a subgroup of the plurality of student computers is defined; wherein
inputs made using the input device of any one of the student computers within said subgroup will be displayed on the graphical user interface of each student computer within said subgroup;
whereby the teacher can form interactive student peer groups.

36. The electronic classroom of claim 31, wherein
at least one of the plurality of student computers is located in a different room from the teacher computer.

37. The electronic classroom of claim 31, wherein
at least one of the plurality of student computers is located a substantial distance from the teacher computer.

38. The electronic classroom of claim 37, wherein
said at least one of the plurality of student computers is located at a student's home.

39. The electronic classroom of claim 37, wherein
said at least one of the plurality of student computers is in communication with the teacher computer via the Internet.

40. The electronic classroom of claim 31, further comprising:
a remote monitoring computer located apart from the teacher computer and connected to the teacher computer via a data link; wherein
the remote monitoring computer includes a display device and associated software to display the image that is being displayed on the teacher computer's display device;
whereby a remote user can monitor the teacher's class activities.

41. The electronic classroom of claim 31, further comprising:
a remote monitoring computer located apart from the plurality of student computers and connected to one of the plurality of student computers via a data link; wherein
the remote monitoring computer includes a display device and associated software that displays the image that is being displayed on the graphical user interface of said one of the plurality of student computers;
whereby a remote user can monitor the student's activities.

42. A method of classroom instruction, comprising the steps of:
(a) providing a teacher computer and a plurality of student computers operatively coupled by a data link, each of the student computers including software for providing a graphical user interface, which provides a lesson to the student, and the teacher computer including software for providing a graphical user interface for monitoring and controlling the lessons on the student computers;
(b) selecting a lesson on the teacher computer graphical user interface by a teacher;
(c) selecting a plurality of students on the teacher computer graphical user interface by the teacher;
(d) presenting the selected lesson to the selected plurality of students on the plurality of student computer graphical user interfaces;
(e) receiving inputs by the teacher computer software from each of the selected plurality of students using the student computer graphical user interfaces; and
(f) presenting a response generated by the teacher using the teacher computer input device to at least one of the selected plurality of students on the student computer graphical user interface.

43. The method of claim 42, wherein
the selecting step (b) comprises choosing a lesson from a list of available lessons.

44. The method of claim 42, wherein
the selecting step (b) comprises composing a lesson by the teacher on the teacher computer graphical user interface.

45. The method of claim 42, wherein
the selecting step (c) comprises choosing a plurality of students from a list of available students.

46. The method of claim 42, wherein
the presenting step (d) further comprises the steps of:
(d1) making a first control input by the teacher using the teacher computer input device to present a first portion of the lesson to the selected plurality of students on the student computer graphical user interfaces;
(d2) making a next control input by the teacher on the teacher computer to present a next portion of the lesson to the selected plurality of students on the student computers; and
(d3) repeating step (d2) until the entire lesson has been presented.

47. The method of claim 42, further comprising the step of:
comparing the each of the selected plurality of students' inputs to a pre-determined reference by the teacher computer software.

48. The method of claim 42, wherein
the presenting step (f) generates a report card summarizing the student's performance.

49. The method of claim 42, wherein
the presenting step (f) communicates a visual symbol qualifying the student's performance to the student by the teacher.

50. The method of claim 42, wherein
the presenting step (f) includes a step of presenting an additional portion of the lesson to the student on the student computer graphical user interface.

51. The method of claim 42, wherein
the presenting step (f) includes a step of presenting a second lesson to the student on the student computer graphical user interface.

52. The method of claim 42, wherein
steps (d) through (f) are performed substantially in real time.

53. The method of claim 42, wherein
at least one of the steps (d) through (f) is separated in time.
